(19) United States
(12) Patent Application Publication
(10) Pub. No.: US 2026/0229907 A1
(43) Pub. Date: Aug. 6, 2026

(54) System for charging, cooling and heating rechargeable batteries

(71) Applicant: Hilti Aktiengesellschaft, Schaan (LI)

(72) Inventors: Klaus HAUSER, Schwabmünchen (DE); Moses ENDER, Kaufering (DE); Daniel SELTMANN, Türkheim (DE); Robert STANGER, Kaufbeuren (DE); Markus HARTMANN, Mauerstetten (DE); Mathias FRENZEL, Unterdießen (DE); Markus HOLUBARSCH, Landsberg am Lech (DE); Rory BRITZ, Starnberg (DE)

(21) Appl. No.: 19/154,016

(22) PCT Filed: Jan. 11, 2024
(86) PCT No.: PCT/EP2024/050533

§ 371 Date: Aug. 6, 2025

(30) Foreign Application Priority Data
Feb. 15, 2023 (EP) 23156735.5

(51) Int. Cl. H02J 7/70; H01M 10/46; H01M 10/613; H01M 10/615; H01M 10/63; H01M 10/6563

(52) U.S. Cl. CPC H02J 7/751; H01M 10/46; H01M 10/613; H01M 10/615; H01M 10/63; H01M 10/6563

(57) ABSTRACT

System having at least one first receiving apparatus for receiving at least one first rechargeable battery, wherein the at least first rechargeable battery includes a temperature sensor for measuring at least one temperature value of the rechargeable battery, wherein the at least first receiving apparatus includes a charging device for charging the rechargeable battery with electrical energy, a cooling device for cooling the rechargeable battery, and a heating device for heating the rechargeable battery.

The present invention relates to a system having at least one first receiving apparatus for receiving at least one first rechargeable battery.

### BACKGROUND

Rechargeable batteries (also known as accumulators) are widely known in the prior art as an energy supply for a power tool. These rechargeable batteries usually include a number of energy storage cells (also referred to as rechargeable-battery cells), which serve and are designed to receive, store, and deliver electrical energy. The receiving of electrical energy into the energy storage cells can also be referred to as charging (or recharging). The delivery of electrical energy from the energy storage cells can also be referred to as discharging.

For charging or recharging with electrical energy, the rechargeable battery is usually connected to a charging device (also called a charger). The charging device conducts electrical energy in accordance with a predetermined charging setting (also called the charging mode) having defined parameters for the actual charging process at the individual energy storage cells of the rechargeable battery.

### SUMMARY OF THE INVENTION

In order to achieve virtually optimal charging of a rechargeable battery with electrical energy and virtually optimum discharging of the rechargeable battery (i.e. the re-delivery of the energy stored in the rechargeable battery to a power tool for example), the parameters of the rechargeable battery should be between minimum and maximum threshold values. Operating, i.e. charging and also discharging, a rechargeable battery outside of the threshold values can result in substantially longer charging times, a lesser capacity and/or a lower discharge current value.

Keeping the parameters of the rechargeable battery in the ideal range or between the threshold values can be ensured only with difficulty, in particular when the rechargeable batteries are being used outside and in the case of extreme weather conditions.

It is an object of the present invention to solve the problem described above.

The present invention provides a system having at least one first receiving apparatus for receiving at least one first rechargeable battery, wherein the at least first rechargeable battery includes a temperature sensor for measuring at least one temperature value of the rechargeable battery.

According to the invention, provision is made for the at least first receiving apparatus to include a charging device for charging the rechargeable battery with electrical energy, a cooling device for cooling the rechargeable battery, and a heating device for heating the rechargeable battery.

In order to store electrical energy, the rechargeable battery includes at least one energy storage cell. It should be noted that the temperature sensor of the rechargeable battery is in particular, but not exclusively, designed to measure the temperature of the at least one energy storage cell. In one embodiment in which the rechargeable battery includes a multiplicity of energy storage cells, the temperature sensor is designed and positioned in such a way as to measure at least the temperature of the energy storage cell that is arranged furthest away from an outer wall of the rechargeable battery.

According to a further advantageous exemplary embodiment, it may be possible for a diagnosis device for ascertaining at least one parameter of the rechargeable battery to be included. The parameters of the rechargeable battery may be the electrical voltage, the capacity, the temperature, the electrical resistance and the like.

In accordance with one advantageous exemplary embodiment, it may be possible for at least one display device for outputting at least one enable signal or disable signal to be included on the at least first receiving apparatus. In this case, the display device may be designed to output audible and/or visual signals. The display device may be used to provide a user of the system with information about the state of the system and/or of a rechargeable battery.

According to a further advantageous exemplary embodiment, it may be possible for the receiving apparatus to be in the form of a chamber, wherein the chamber has at least one volume for receiving at least one rechargeable battery, and at least one reclosable opening for placing the at least one rechargeable battery inside the chamber. The chamber or the insulating effect of the chamber may be used to more easily reach and maintain a desired temperature for a rechargeable battery positioned in the chamber.

In accordance with one advantageous exemplary embodiment, it may be possible for at least one second receiving apparatus for receiving at least one second rechargeable battery to be included. This makes it possible to position a plurality of rechargeable batteries in the system simultaneously.

According to a further advantageous exemplary embodiment, it may be possible for an accepting device and a first transport device to be included, wherein the accepting device is designed to receive at least one rechargeable battery, and the first transport device is designed to transport the at least one rechargeable battery to a receiving apparatus.

In accordance with one advantageous exemplary embodiment, it may be possible for a storage device and a second transport device to be included, wherein the storage device is designed to at least temporarily store at least one rechargeable battery, and the second transport device is designed to transport the at least one rechargeable battery from a receiving apparatus to the storage device.

### BRIEF DESCRIPTION OF THE DRAWINGS

Further advantages can be found in the following description of the figures. A particularly preferred exemplary embodiment of the present invention is illustrated in the figures. The figures, the description and the claims include numerous features in combination. A person skilled in the art will expediently also consider the features individually and combine them to form sensible further combinations.

Identical and similar components are denoted by the same reference signs in the figures,

in which:

FIG. 1 shows a perspective view of a system having a first and a second receiving apparatus according to a first exemplary embodiment;

FIG. 2 shows a perspective view of a system having the first and the second receiving apparatus according to the first exemplary embodiment in an activated state;

FIG. 3 shows a perspective view of a receiving apparatus according to a first exemplary embodiment; and

FIG. 4 shows a perspective view of a system having a first, a second and a third receiving apparatus according to a second exemplary embodiment.

### DETAILED DESCRIPTION

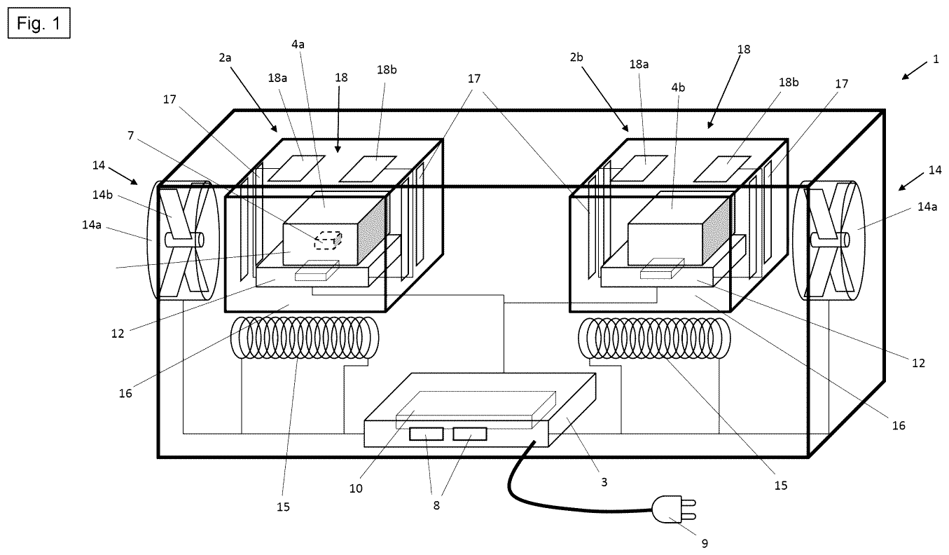

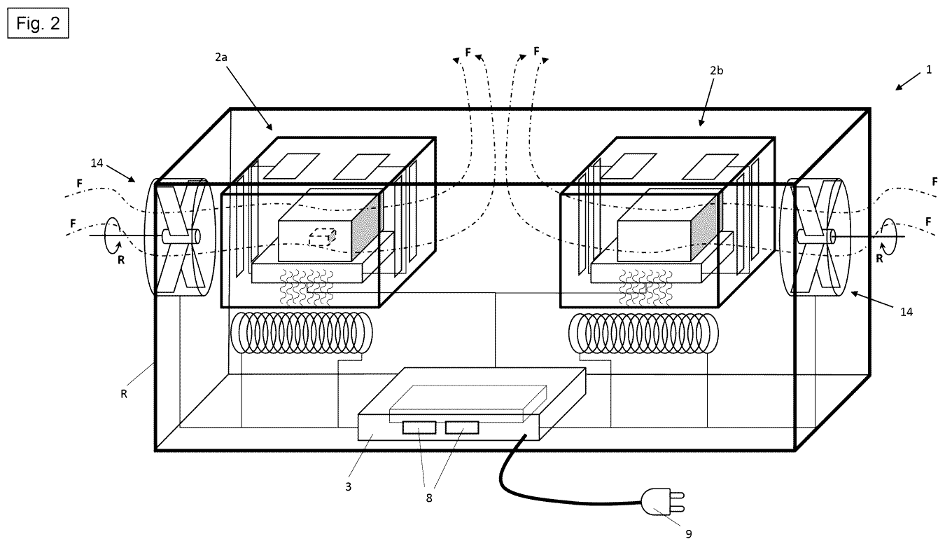

FIGS. 1 and 2 show a system 1 according to the invention having a first receiving apparatus 2a and second receiving apparatus 2b as well as a control unit 3 according to a first exemplary embodiment.

A first rechargeable battery 4a is positioned in the first receiving apparatus 2a, and a second rechargeable battery 4b is positioned in the second receiving apparatus 2b.

The two rechargeable batteries 4a, 4b are structurally identical in the first exemplary embodiment. However, it is also possible for the rechargeable batteries 4a, 4b not to be structurally identical or to be designed differently.

The rechargeable battery 4a, 4b may be releasably connected to a power tool in order to supply the power tool with electrical energy.

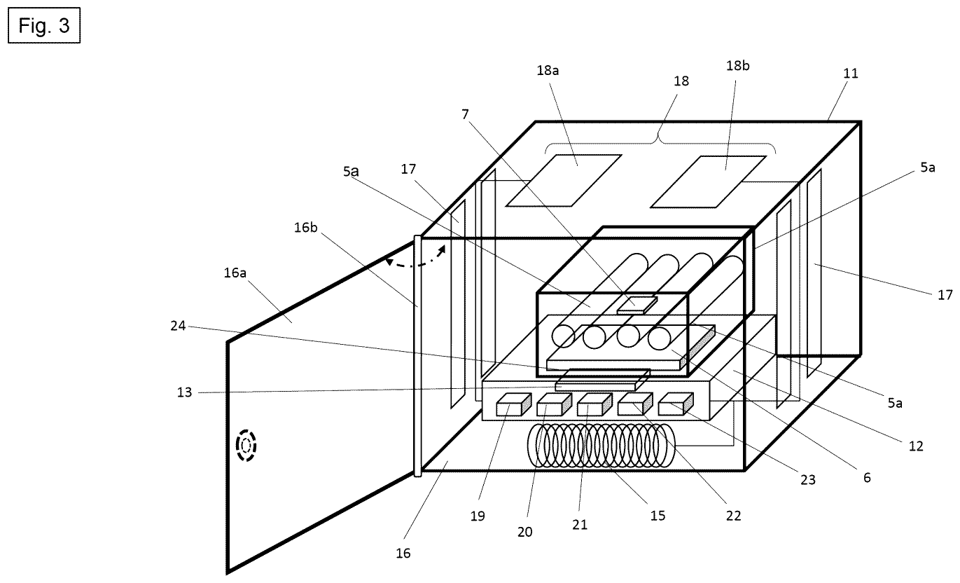

Furthermore, as shown for example in FIG. 3, the rechargeable battery 4a, 4b substantially includes a rechargeable-battery housing 5, a number of energy storage cells 5a, a rechargeable-battery interface, and a control device 6.

The energy storage cells 5a may also be referred to as rechargeable-battery cells and are arranged inside the rechargeable-battery housing 5.

In this case, the rechargeable-battery housing 5 substantially includes a cover element, four side walls, and a base element.

The rechargeable-battery interface is arranged on the outer side of the cover element and serves to electrically or electronically connect, as well as mechanically connect, the rechargeable battery 4a, 4b to the power tool or to the receiving apparatus 2a, 2b.

For the purpose of the electrical or electronic connection, the rechargeable-battery interface has a positive contact, a negative contact, and a communication contact. The positive contact and negative contact serve to produce a circuit when the rechargeable battery 4a, 4b is connected to a power tool or to the receiving apparatus 2a, 2b. The communication contact serves to send and receive data and information in the form of electrical signals.

Alternatively or in addition, the rechargeable battery 4a, 4b may also include a radio communication (e.g. Bluetooth) or wireless communication.

The energy storage cells 5a serve to receive, store and re-deliver electrical energy. As indicated in the figures, the energy storage cells 5a are cylindrical and designed on the basis of lithium-ion technology. Each energy storage cell 5a includes, at one end, a contact device which serves for the transmission of electrical energy. The individual contact devices are connected to the control device 6 via corresponding lines.

Alternatively, the energy storage cells 5a may also be based on another suitable technology.

The cylindrical shape of the energy storage cells 5a is likewise exemplary, so any other suitable shape or geometry may also be selected. It is thus in particular also possible for the energy storage cells 5a to be in the form of pouch cells.

It is additionally also possible for the rechargeable battery 4a, 4b to include both cylindrical energy storage cells 5a and pouch cells. It is in particular possible for the rechargeable battery 4a, 4b to include a single cylindrical energy storage cell 5a and a single pouch cell.

The control device 6 controls the different functions of the rechargeable battery 4a, 4b in a closed-loop and open-loop manner. Furthermore, the control device 6 includes a temperature sensor 7 for measuring at least one temperature value of the rechargeable battery 4a, 4b. As indicated in the figures, the temperature sensor 7 is positioned in the center of the rechargeable battery 4a, 4b, i.e. near to the energy storage cell 5a that is furthest away from the walls of the rechargeable-battery housing 5. When the rechargeable battery 4a, 4b is being used, this energy storage cell 5a is usually the hottest and as a result is most susceptible to heat-related damage.

Additionally, the control device 6 is connected to the energy storage cells 5a and the rechargeable-battery interface via corresponding lines such that electrical energy can pass from the energy storage cells 5a via the control device 6 to the rechargeable-battery interface.

To releasably mechanically couple the rechargeable battery 4a, 4b to the power tool, a rail apparatus is provided.

A locking apparatus serves to releasably connect the rechargeable battery 4a, 4b to the power tool or to the receiving apparatus 2a, 2b.

The control unit 3 of the system 1 serves to control the individual functions of the system 1, and in particular the functions of the receiving apparatus 2a, 2b, in a closed-loop and open-loop manner. Furthermore, the control unit 3 includes an input and output device 8, a mains connection 9 and a memory 10.

As indicated in FIGS. 1, 2 and 4, the mains connection 9 is in the form of a power cable in order to releasably connect the system 1 to a mains power source (e.g. power socket) so that it can be supplied with electrical energy.

The first and second receiving apparatus 2a, 2b are substantially structurally identical according to the first exemplary embodiment.

In this case, each receiving apparatus 2a, 2b includes a chamber 11, a diagnosis device 12, a charging device 13, a cooling device 14 and a heating device 15.

As indicated in FIG. 1, the system 1 according to the first exemplary embodiment includes a frame R. The two receiving apparatuses 2a, 2b and the control unit 3 are positioned in the frame R. As indicated likewise in FIG. 1, the cooling device 14 for the first receiving apparatus 2a is positioned on one side of the frame R, and the cooling device 14 for the second receiving apparatus 2b is positioned on another side. Instead of a frame R, a closed or virtually closed case may also be provided.

As can be gathered from the figures, the chamber 11 substantially has a base, a cover, three side walls and an opening 16. The chamber 11 has a volume (or interior space) for receiving a rechargeable battery 2a, 2b.

The opening 16 is in the form of a door 16a having a hinge 16b so that the chamber 11 can be closed. Furthermore, the opening 16 is at least large enough for a rechargeable battery 2a, 2b to pass through it. In accordance with a further exemplary embodiment, the chamber 11 has no door and so the chamber 11 is always open on one side.

Additionally, two opposite side walls include elongate ventilation openings 17. Alternatively or in addition, the cover may also include at least one ventilation opening 17.

The ventilation openings 17 serve to allow the cooling air to flow into the interior of the chamber 11 and to flow back out of the chamber 11.

As indicated in the figures, a display device 18 for outputting at least one enable signal or disable signal is further positioned on an outer side of the cover of the chamber 11. In this case, the display device 18 is designed to be able to output audible and/or visual signals. It is additionally possible for further signals to be able to be emitted in addition to an enable signal or disable signal. In the present exemplary embodiment, the display device 18 is in the form of a first and second LED light 18a, 18b, wherein a green LED light 18a displays the enable signal, and a red LED light 18b displays the disable signal.

The diagnosis device 12 serves to ascertain at least one parameter of the rechargeable battery 4a, 4b and is connected to the control unit 3 and to the memory 10 of the system 1 in such a way that data and information can be exchanged in the form of signals.

The parameters are the electrical voltage, the capacity, the temperature, the electrical resistance and the like. As indicated in FIG. 3, the diagnosis device 12 therefore includes a measuring device for the electrical voltage 19, a measuring device for the electrical capacity 20, a temperature sensor for measuring temperature values 21, a measuring device for the electrical resistance 22, and a measuring device for the electrical current intensity 23.

The diagnosis device 12 includes an interface 24 by means of which the rechargeable battery 4a, 4b can be releasably connected to the diagnosis device 12. In this case, the interface 24 substantially includes a positive contact, a negative contact and a communication contact. If the rechargeable battery 4a, 4b is intended to be placed in contact with the diagnosis device 12, the communication contact of the diagnosis device 12 and the communication contact of the rechargeable-battery interface are connected to one another in such a way that data and information can be exchanged in the form of signals. In the event of a connection, the parameters of the rechargeable battery 4a, 4b are transmitted to the diagnosis device 12 in this way. In the alternative exemplary embodiment, the parameters of the rechargeable battery 4a, 4b may also be transmitted from the rechargeable battery 4a, 4b to the diagnosis device 12 wirelessly or via radio.

The charging device 13 serves to charge the rechargeable battery 4a, 4b with electrical energy and is connected to the diagnosis device 12, cf. in particular FIG. 3. The connection to the diagnosis device 12 makes it possible for the charging device 13 to guide electrical energy to the rechargeable battery 4a, 4b via the interface 24. The charging device 13 may also likewise draw electrical energy from the rechargeable battery 4a, 4b.

The cooling device 14 (see, e.g., FIG. 1) serves to cool the rechargeable battery 4a, 4b by means of an air flow F and in the present exemplary embodiments is in the form of a fan 14a having a fan wheel 14b. In the present exemplary embodiment, a fan 14a is in each case positioned next to a side wall of the chamber 11 which has ventilation openings 17. If, as indicated in FIG. 2, the cooling device 14 in the form of a fan 14a generates an air flow F, this air flow can flow into the chamber 11 through the ventilation openings 17 in a first side wall and flow along the rechargeable battery 4a, 4b and flow back out of the chamber 11 through the ventilation openings 17 in a second side wall.

The heating device 15 serves to heat the rechargeable battery 4a, 4b. In the present exemplary embodiment, the heating device 15 is in the form of a heating coil. It is possible for the heating device 15 to consist of more than a single heating coil. As shown in the figures, the heating device 15 in the form of a heating coil is fixed in the base of the chamber 11 or beneath a rechargeable battery 4a, 4b positioned in the chamber 11. Alternatively or in addition, a heating device 15 in the form of a heating coil may be positioned in the cover and/or on a side wall of the chamber 11.

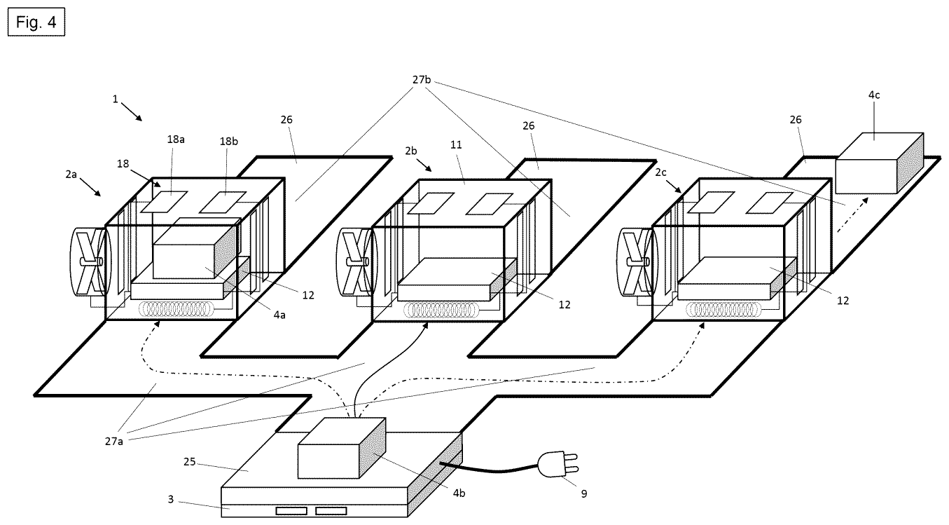

FIG. 4 shows a system 1 according to the invention according to a second exemplary embodiment having a first, second and third receiving apparatus 2a, 2b, 2c and a control unit 3. In contrast to the first exemplary embodiment, the system 1 according to the second exemplary embodiment includes a third receiving apparatus 2c, an accepting device 25, a storage device 26, a first and second transport device 27a, 27b.

The third receiving apparatus 2c is substantially structurally identical to the first and/or second receiving apparatus 2a, 2b in the first exemplary embodiment.

The accepting device 25 serves to receive or accept a first, second or third rechargeable battery 4a, 4b, 4c and according to the second exemplary embodiment is substantially in the form of a plate or platform. In this case, the essential function of the accepting device 25 is to create a safe storage option for a rechargeable battery 4a, 4b, 4c, by way of which the rechargeable battery 4a, 4b, 4c can be carried further. In the second exemplary embodiment, the first transport device 27a is in the form of a conveyor belt and is arranged between the accepting device 25 and the receiving apparatuses 2a, 2b, 2c in such a way that a rechargeable battery 4a, 4b, 4c can be transported from the accepting device 25 to a receiving apparatus 2a, 2b, 2c.

Alternatively, the first transport device 27a may also be in the form of a roller conveyor having a drive for the rollers.

The storage device 26 serves, like the accepting device 25, to receive or accept a rechargeable battery 4a, 4b, 4c and according to the second exemplary embodiment is substantially in the form of a plate or platform. In this case, the essential function of the storage device 26 is to create a safe storage option for a rechargeable battery 4a, 4b, 4c, by way of which the rechargeable battery 4a, 4b, 4c can be carried further. In the second exemplary embodiment, the second transport device 27b is likewise in the form of a conveyor belt and is arranged between the receiving apparatuses 2a, 2b, 2c and the storage device 26 in such a way that a rechargeable battery 4a, 4b, 4c can be transported from a receiving apparatus 2a, 2b, 2c to the storage device 26.

Alternatively, the second transport device 27b may also be in the form of a roller conveyor having its own drive for the rollers. Furthermore, the rollers of the second transport device 27b may also be driven by the drive of the first transport device 27a.

In order to operate the system 1 according to the invention according to the first exemplary embodiment, a rechargeable battery 4a, 4b, 4c is positioned in the first receiving apparatus 2a. The rechargeable battery 4a, 4b, 4c is connected to the interface 24 of the diagnosis device 12 by means of the rechargeable-battery interface. The connection of the rechargeable battery 4a, 4b, 4c to the diagnosis device 12 makes it possible for data and information to be exchanged between the rechargeable battery 4a, 4b, 4c and the diagnosis device 12. In this case, the rechargeable battery 4a, 4b, 4c transmits the capacity values, the voltage value and the temperature value to the diagnosis device 12. In this case, the rechargeable battery 4a, 4b, 4c includes a temperature sensor 21 and measures the temperature of the energy storage cells 5a. If the diagnosis device 12 ascertains, on the basis of the measured and transmitted temperature value, that this temperature value is below a first predetermined threshold value, the heating device 15 is activated to heat the rechargeable battery 4a, 4b, 4c.

Alternatively or in addition to this, the control device 6 of the rechargeable battery 4a, 4b, 4c may ascertain, on the basis of the temperature value measured by the temperature sensor 21 of the rechargeable battery 4a, 4b, 4c, that this temperature value is below a first predetermined threshold value. The control device 6 of the rechargeable battery 4a, 4b, 4c sends a corresponding signal to the control unit 3 of the system 1 so that the heating device 15 heats the rechargeable battery 4a, 4b, 4c.

The first temperature threshold value is stipulated specifically for the respective rechargeable battery 4a, 4b, 4c and stored in the memory 10 of the control unit 3 of the system 1. The first temperature threshold value is stipulated as a temperature value that is too low for an approximately optimal charging of the rechargeable battery 4a, 4b, 4c with electrical energy. By way of example, it is thus possible for the first temperature threshold value to be 5° C. Alternatively, the first temperature threshold value may also be higher or lower than 5° C.

When by means of the heating device 15 the temperature of the rechargeable battery 4a, 4b, 4c is above the first temperature threshold value (i.e. higher than 5° C.), this is measured by the temperature sensor 21 of the rechargeable battery 4a, 4b, 4c and a corresponding signal is transmitted to the control unit 3. Once the rechargeable battery 4a, 4b, 4c then has a temperature above the first temperature threshold value, which is better suited for a charging process with electrical energy, the actual charging process by means of the charging device 13 can be started such that electrical energy can reach the rechargeable battery 4a, 4b, 4c from the control unit 3.

The measuring device 19 for the electrical voltage of the rechargeable battery 4a, 4b, 4c measures or ascertains the voltage value of the energy storage cells 5a. In order to charge the energy storage cells 5a with electrical energy, a corresponding signal is sent from the control device 6 of the rechargeable battery 4a, 4b, 4c to the control unit 3 of the system 1. After receiving the signal, the control unit 3 of the system 1 sends electrical energy to the energy storage cells 5a. In this case, the desired voltage value (i.e. volt) for the charging process is transmitted from the rechargeable battery 4a, 4b, 4c to the control unit 3 of the system 1 by the corresponding signal. Additionally, a suitable or desired current intensity value (i.e. ampere) is also transmitted from the rechargeable battery 4a, 4b, 4c to the system 1 by means of the emitted signal and is thus predefined by the rechargeable battery 4a, 4b, 4c for the charging process.

During the charging, the measuring device 19 for the electrical voltage of the rechargeable battery 4a, 4b, 4c measures the present voltage value of the energy storage cells 5a. In addition to the measuring device 19 for the electrical current intensity, the measuring device for the electrical current intensity 23 also measures, during the charging process, the current intensity (i.e. A or Ah) of the electrical energy transmitted for the charging process. After reaching a predetermined voltage value for the energy storage cells 5a, i.e. for example 70 or 80% of the maximum voltage value or capacity of the rechargeable battery 4a, 4b, 4c, the charging process is stopped.

During the charging process, it is possible for the cooling device 14 to cool the rechargeable battery 4a, 4b, 4c in order to cool the rechargeable battery 4a, 4b, 4c or the energy storage cells 5a to a temperature value that is below a second temperature threshold value. According to the exemplary embodiment, the second temperature threshold value is 60° C.

Alternatively, the second temperature threshold value may also be higher or lower than 60° C.

Additionally, during the charging process, it is also possible for the heating device 15 to heat the rechargeable battery 4a, 4b, 4c in order to heat the rechargeable battery 4a, 4b, 4c or the energy storage cells 5a to a temperature value that is above a first temperature threshold value.

In order to operate the system 1 according to the invention according to the second exemplary embodiment, a rechargeable battery 4a, 4b, 4c is positioned in the first receiving apparatus 2a.

A rechargeable battery 4a, 4b, 4c is positioned on the accepting device 25. The control unit 3 of the system 1 ascertains which receiving apparatus 2a, 2b, 2c is available, i.e. in which receiving apparatus 2a, 2b, 2c there is currently no rechargeable battery 4a, 4b, 4c. If the rechargeable battery 4a, 4b, 4c is intended to be transported into the second receiving apparatus 2b, the first transport device 27a transports the rechargeable battery 4a, 4b, 4c from the accepting device 25 to the second receiving apparatus 2b. When the rechargeable battery 4a, 4b, 4c has arrived in the second receiving apparatus 2b, the rechargeable-battery interface is connected to the interface 24 of the diagnosis device 12. Once the corresponding data and information have been transmitted in the form of signals from the control device 6 of the rechargeable battery 4a, 4b, 4c to the control unit 3 of the system 1, the charging process controlled in a closed-loop manner by the rechargeable battery 4a, 4b, 4c is carried out. The cooling device 14 and heating device 15 likewise controlled in a closed-loop or open-loop manner by the control device 6 of the rechargeable battery 4a, 4b, 4c are activated when the corresponding temperature threshold values are reached.

Once the charging process has ended, the rechargeable battery 4a, 4b, 4c is transported from the second receiving apparatus 2b to the storage device 26 by means of the second transport device. The rechargeable battery 4a, 4b, 4c charged with electrical energy can be removed from the storage device 26 by a user.

### LIST OF REFERENCE SIGNS

1 system
2a first receiving apparatus
2b second receiving apparatus
2c third receiving apparatus
3 control unit
4a first rechargeable battery
4b second rechargeable battery
4c third rechargeable battery
5 rechargeable-battery housing
5a energy storage cell
6 control device
7 temperature sensor
8 input and output device
9 mains connection
10 memory
11 chamber
12 diagnosis device
13 charging device
14 cooling device
14a fan
14b fan wheel
15 heating device
16 opening
16a door
16b hinge
17 ventilation opening
18 display device
18a first LED light
18b second LED light
19 measuring device for the electrical voltage
20 measuring device for the electrical capacity
21 temperature sensor for measuring temperature values
22 measuring device for the electrical resistance
23 measuring device for the electrical current intensity
24 interface
25 accepting device
26 storage device
27a first transport device
27b second transport device
F air flow
R frame

1-7. (canceled)

8: A system comprising:
at least one first receiver for receiving at least one first rechargeable battery, the first rechargeable battery including a temperature sensor for measuring at least one temperature value of the first rechargeable battery;
the first receiver including a charger for charging the rechargeable battery with electrical energy, a cooler for cooling the rechargeable battery, and a heater for heating the rechargeable battery.

9: The system as recited in claim 8 further comprising a diagnostic tool for ascertaining at least one parameter of the rechargeable battery.

10: The system as recited in claim 8 further comprising a display device for outputting at least one enable signal or disable signal on the first receiver.

11: The system as recited in claim 8 wherein the first receiver is in the form of a chamber, the chamber having at least one volume for receiving the first rechargeable battery, and at least one reclosable opening for placing the first rechargeable battery inside the chamber.

12: The system as recited in claim 8 further comprising at least one second receiver for receiving at least one second rechargeable battery.

13: The system as recited in claim 8 further comprising an acceptor and a first transporter, the acceptor designed to receive the first rechargeable battery and the first transporter designed to transport the first rechargeable battery to the first receiver.

14: The system as recited in claim 8 further comprising a storage and a transporter, the storage designed to at least temporarily store the first rechargeable battery, and the transporter designed to transport the first rechargeable battery from the first receiver to the storage.
